(19) United States
(12) Patent Application Publication
(10) Pub. No.: US 2016/0292325 A1
(43) Pub. Date: Oct. 6, 2016

(54) ADVANCED DATA CLEANSING SYSTEM AND METHOD

(71) Applicant: UOP LLC, Des Plaines, IL (US)

(72) Inventors: Ian G. Horn, Streamwood, IL (US); Christophe Romatier, Wilmette, IL (US); Paul Kowalczyk, Hoffman Estates, IL (US); Zak Alzein, Burr Ridge, IL (US)

(21) Appl. No.: 15/084,291

(22) Filed: Mar. 29, 2016

Related U.S. Application Data
(60) Provisional application No. 62/140,039, filed on Mar. 30, 2015.

(51) Int. Cl. G06F 17/50; G01F 15/02; H04L 29/08

(52) U.S. Cl. CPC G06F 17/5009; H04L 67/02; G01F 15/022

(57) ABSTRACT

A cleansing system for improving operation of a plant. A server is coupled to the cleansing system for communicating with the plant via a communication network. A computer system has a web-based platform for receiving and sending plant data related to the operation of the plant over the network. A display device interactively displays the plant data. A data cleansing unit is configured for performing an enhanced data cleansing process for allowing an early detection and diagnosis of the operation of the plant based on at least one environmental factor. The data cleansing unit calculates and evaluates an offset amount representing a difference between a measurement and a simulation for detecting an error of measurement during the operation of the plant based on the plant data.

### CROSS-REFERENCE

This application claims priority under 35 U.S.C. §119(e) of U.S. Provisional Application Ser. No. 62/140,039 filed Mar. 30, 2015 which is incorporated herein by reference in its entirety.

### FIELD OF THE INVENTION

The present invention is related to data cleansing processes for a plant, such as a chemical plant or refinery, and more particularly to a method and system for performing a data cleansing process for early fault diagnosis of plant operation.

### BACKGROUND OF THE INVENTION

Companies operating refineries and petrochemical plants typically face tough challenges in today's environment. These challenges can include eroding financial margins, increasingly complex technologies, a reduction in workforce experience levels, and constantly changing environmental regulations.

Furthermore, as feed and product prices become more volatile, operators often find it more difficult to make the operating decisions that can optimize their financial margin. This volatility may be unlikely to ease in the foreseeable future; however, it can represent economic potential to those companies that can quickly identify and respond to market opportunities as they arise.

Pressures from capital markets generally force operating companies to continually increase the return on existing assets. In response, catalyst, adsorbent, equipment, and control system suppliers develop more complex systems that can increase asset performance. Maintenance and operations of these advanced systems generally requires increased skill levels that can be difficult to develop, maintain, and transfer given the time pressures and limited resources of today's technical personnel. This means that these increasingly complex systems are not always operated to their highest potential. In addition, when existing assets are operated close to and beyond their design limits, reliability concerns and operational risks can increase.

Plant operators typically respond to above challenges with one or more of several strategies, such as, for example, availability risk reduction, working the value chain and continuous economic optimization. Availability risk reduction generally places an emphasis on achieving adequate plant operations as opposed to maximizing economic performance. Working the value chain typically places an emphasis on improving the match of feed and product mix with asset capabilities and market demands. Continuous economic optimization often employs tools, systems and models to continuously monitor and bridge the economic and operational gaps in plant performance.

In a typical data cleansing process, only flow meters are corrected. Data cleansing is performed to correct flow meter calibration and fluid density changes, after which the total error of flow meters in a mass balance envelope is averaged to force a 100% mass balance between the net feed and net product flows. However, this conventional data cleansing practice ignores other related process information available (e.g., temperatures, pressures, and internal flows) and does not allow for an early detection of a significant error. Specifically, the errors associated with the flow meters are distributed among the flow meters, and thus it is difficult to detect an error of a specific flow meter.

Therefore, there is a need for an improved data cleansing system and method that performs an early detection and diagnosis of plant operation using one or more environmental factors.

### SUMMARY OF THE INVENTION

A general object of the invention is to improve operation efficiency of chemical plants and refineries. A more specific object of this invention is to overcome one or more of the problems described above. A general object of this invention can be attained, at least in part, through a method for improving operation of a plant. The method includes obtaining plant operation information from the plant.

The present invention further comprehends a method for improving operation of a plant that includes obtaining plant operation information from the plant and generating a plant process model using the plant operation information. This invention still further comprehends a method for improving operation of a plant. The method includes receiving plant operation information over the internet and automatically generating a plant process model using the plant operation information.

The present invention performs an enhanced data cleansing process to allow an early detection and diagnosis of measurement errors based on one or more environmental factors. The environmental factors include at least one primary factor, and an optional secondary factor. The primary factor includes, for example, a temperature, a pressure, a feed flow, a product flow, and the like. The secondary factor includes, for example, a density, a specific composition, and the like. Using the primary and secondary factors, at least one offset between the measurement and the process model information is calculated.

The present invention utilizes configured process models to reconcile measurements within individual process units, operating blocks and/or complete processing systems. Routine and frequent analysis of model predicted values versus actual measured values allows early identification of measurement errors which can be acted upon to minimize impact on operations.

The present invention utilizes process measurements from any of the following devices: pressure sensors, differential pressure sensors, orifice plates, venturi, other flow sensors, temperature sensors, capacitance sensors, weight sensors, gas chromatographs, moisture sensors, and other sensors commonly found in the refining and petrochemical industry, as is known in the art. Further, the present invention utilizes process laboratory measurements from gas chromatographs, liquid chromatographs, distillation measurements, octane measurements, and other laboratory measurements commonly found in the refining and petrochemical industry.

The process measurements are used to monitor the performance of any of the following process equipment: pumps, compressors, heat exchangers, fired heaters, control valves, fractionation columns, reactors and other process equipment commonly found in the refining and petrochemical industry.

The method of this invention is preferably implemented using a web-based computer system. The benefits of executing work processes within this platform include improved plant economic performance due to an increased ability by operations to identify and capture economic opportunities, a sustained ability to bridge performance gaps, an increased ability to leverage personnel expertise, and improved enterprise tuning. The present invention is a new and innovative way of using advanced computing technology in combination with other parameters to change the way plants, such as refineries and petrochemical facilities, are operated.

The present invention uses a data collection system at a plant to capture data which is automatically sent to a remote location, where it is reviewed to, for example, eliminate errors and biases, and used to calculate and report performance results. The performance of the plant and/or individual process units of the plant is/are compared to the performance predicted by one or more process models to identify any operating differences, or gaps.

A report, such as a daily report, showing actual measured values compared to predicted values can be generated and delivered to a plant operator and/or a plant or third party process engineer such as, for example, via the internet. The identified performance gaps allow the operators and/or engineers to identify and resolve the cause of the gaps. The method of this invention further uses the process models and plant operation information to run optimization routines that converge on an optimal plant operation for the given values of, for example, feed, products and prices.

The method of this invention provides plant operators and/or engineers with regular advice that enable recommendations to adjust setpoints or reference points allowing the plant to run continuously at or closer to optimal conditions. The method of this invention provides the operator alternatives for improving or modifying the future operations of the plant. The method of this invention regularly maintains and tunes the process models to correctly represent the true potential performance of the plant. The method of one embodiment of this invention includes economic optimization routines configured per the operator's specific economic criteria which are used to identify optimum operating points, evaluate alternative operations and do feed evaluations.

The present invention provides a repeatable method that will help refiners bridge the gap between actual and achievable economic performance. The method of this invention utilizes process development history, modeling and stream characterization, and plant automation experience to address the critical issues of ensuring data security as well as efficient aggregation, tuning and movement of large amounts of data. Web-based optimization is a preferred enabler to achieving and sustaining maximum process performance by connecting, on a virtual basis, technical expertise and the plant process operations staff.

The enhanced workflow utilizes configured process models to monitor, predict, and optimize performance of individual process units, operating blocks, or complete processing systems. Routine and frequent analysis of predicted versus actual performance allows early identification of operational discrepancies which can be acted upon to optimize financial impact.

As used herein, references to a “routine” are to be understood to refer to a sequence of computer programs or instructions for performing a particular task. References herein to a “plant” are to be understood to refer to any of various types of chemical and petrochemical manufacturing or refining facilities. References herein to a plant “operators” are to be understood to refer to and/or include, without limitation, plant planners, managers, engineers, technicians, and others interested in, overseeing, and/or running the daily operations at a plant.

In one embodiment, a cleansing system is provided for improving measurement error estimation and detection. A server is coupled to the cleansing system for communicating with the plant via a communication network. A computer system has a web-based platform for receiving and sending plant data related to the operation of the plant over the network. A display device interactively displays the plant data. A data cleansing unit is configured for performing an enhanced data cleansing process for allowing an early detection and diagnosis of the measurement errors of the plant based on at least one environmental factor. The data cleansing unit calculates and evaluates an offset amount representing a difference between feed or measured and product or simulated information for detecting an error of equipment or measurement during the operation of the plant based on the plant data.

In another embodiment, a cleansing method for improving measurement error detection of a plant is provided, and includes providing a server coupled to a cleansing system for communicating with the plant via a communication network; providing a computer system having a web-based platform for receiving and sending plant data related to the operation of the plant over the network; providing a display device for interactively displaying the plant data, the display device being configured for graphically or textually receiving the plant data; obtaining the plant data from the plant over the network; performing an enhanced data cleansing process for allowing an early detection and diagnosis of the operation of the plant based on at least one environmental factor; and calculating and evaluating an offset amount representing a difference between feed or measured and product or simulated information for detecting an error of equipment or measurement during the operation of the plant based on the plant data.

The foregoing and other aspects and features of the present invention will become apparent to those of reasonable skill in the art from the following detailed description, as considered in conjunction with the accompanying drawings.

### BRIEF DESCRIPTION OF THE DRAWINGS

FIG. 1 illustrates an exemplary use of the present data cleansing system in a network infrastructure;

FIG. 2 is a functional block diagram of the present data cleansing system featuring functional units in accordance with an embodiment of the present disclosure; and

FIG. 3 illustrates an exemplary data cleansing method in accordance with an embodiment of the present data cleansing system.

### DETAILED DESCRIPTION OF THE INVENTION

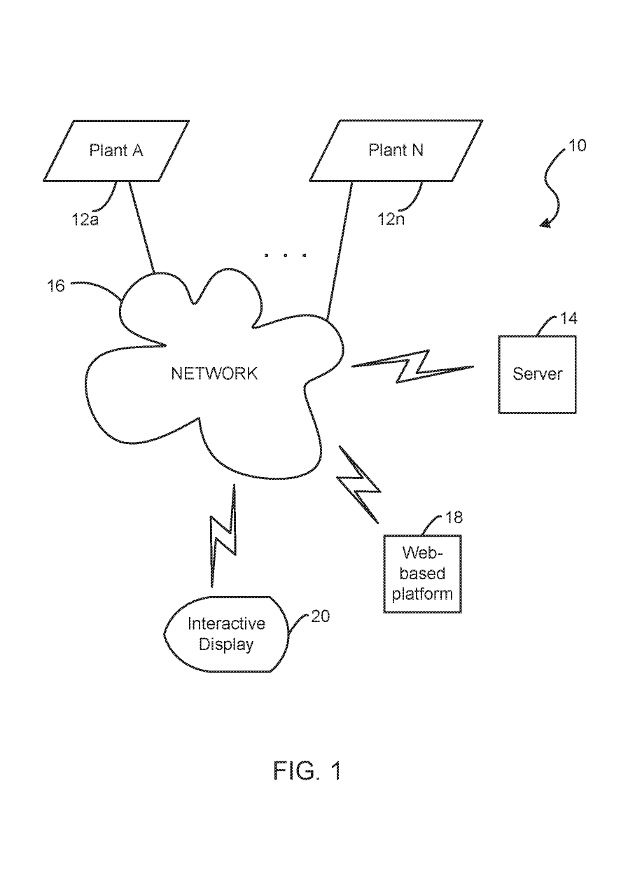

Referring now to FIG. 1, an exemplary data cleansing system, generally designated 10, using an embodiment of the present disclosure is provided for improving operation of one or more plants (e.g., Plant A . . . Plant N) 12a-12n, such as a chemical plant or refinery, or a portion thereof. The present data cleansing system 10 uses plant operation information obtained from at least one plant 12a-12n.

As used herein, the term “system,” “unit” or “module” may refer to, be part of, or include an Application Specific Integrated Circuit (ASIC), an electronic circuit, a computer processor (shared, dedicated, or group) and/or memory (shared, dedicated, or group) that executes one or more software or firmware programs, a combinational logic circuit, and/or other suitable components that provide the described functionality. Thus, while this disclosure includes particular examples and arrangements of the units, the scope of the present system should not be so limited since other modifications will become apparent to the skilled practitioner.

The data cleansing system 10 may reside in or be coupled to a server or computing device 14 (including, e.g., database and video servers), and is programmed to perform tasks and display relevant data for different functional units via a communication network 16, preferably using a secured cloud computing infrastructure. It is contemplated that other suitable networks can be used, such as the internet, a wireless network (e.g., Wi-Fi), a corporate Intranet, a local area network (LAN) or a wide area network (WAN), and the like, using dial-in connections, cable modems, high-speed ISDN lines, and other types of communication methods known in the art. All relevant information can be stored in databases for retrieval by the data cleansing system 10 or the computing device 14 (e.g., as a data storage device and/or a machine readable data storage medium carrying computer programs).

Further, the present data cleansing system 10 can be partially or fully automated. In one preferred embodiment of this invention, the data cleansing system 10 is performed by a computer system, such as a third-party computer system, remote from the plant 12a-12n and/or the plant planning center. The present data cleansing system 10 preferably includes a web-based platform 18 that obtains or receives and sends information over the internet. Specifically, the data cleansing system 10 receives signals and parameters from at least one of the plants 12a-12n via the communication network 16, and displays, preferably in real time, related performance information on an interactive display device 20 accessible to an operator or user.

Using a web-based system for implementing the method of this invention provides many benefits, such as improved plant economic performance due to an increased ability by plant operators to identify and capture economic opportunities, a sustained ability to bridge plant performance gaps, and an increased ability to leverage personnel expertise and improve training and development. The method of this invention allows for automated daily evaluation of process measurements, thereby increasing the frequency of performance review with less time and effort required from plant operations staff.

The web-based platform 18 allows all users to work with the same information, thereby creating a collaborative environment for sharing best practices or for troubleshooting. The method of this invention provides more accurate prediction and optimization results due to fully configured models which can include, for example, catalytic yield representations, constraints, degrees of freedom, and the like. Routine automated evaluation of plant planning and operation models allows timely plant model tuning to reduce or eliminate gaps between plant models and the actual plant performance. Implementing the method of this invention using the web-based platform 18 also allows for monitoring and updating multiple sites, thereby better enabling facility planners to propose realistic optimal targets.

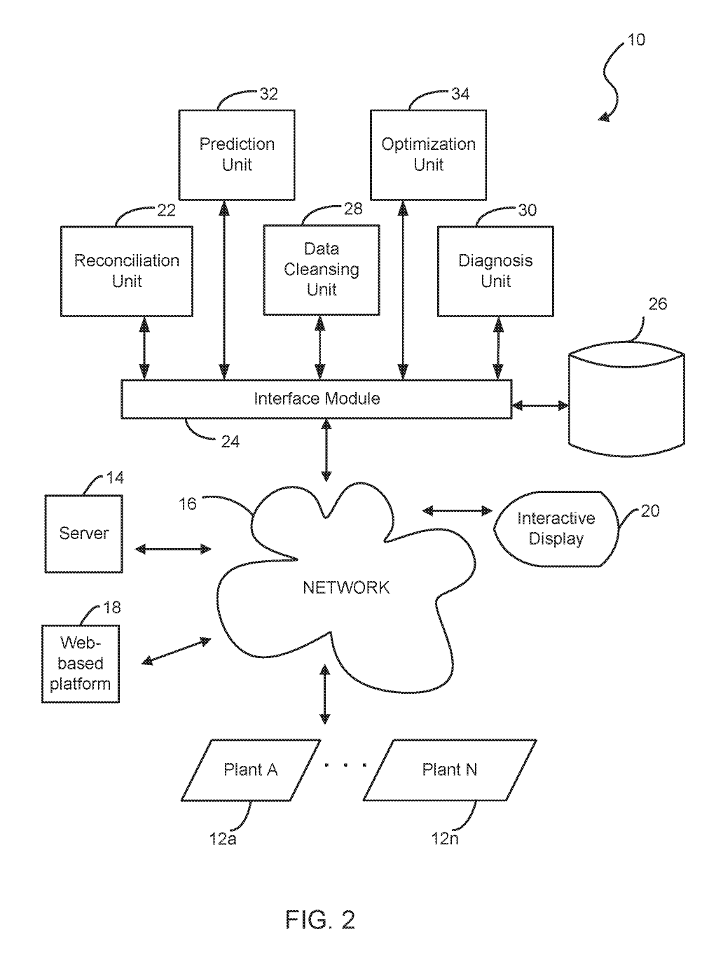

Referring now to FIG. 2, it is preferred that the present data cleansing system 10 includes a reconciliation unit 22 configured for reconciling actual measured data from the respective plants 12a-12n in comparison with process model results from a simulation engine based on a set of reference or set points. In a preferred embodiment, a heuristic analysis is performed against the actual measured data and the process model results using a set of predetermined threshold values. It is also contemplated that a statistical analysis and other suitable analytic techniques can be used to suit different applications.

As an example only, kinetic or other associated plant parameters relating to temperatures, pressures, feed compositions, fractionation columns, and the like, are received from the respective plants 12a-12n. These plant parameters represent the actual measured data from selected pieces of equipment in the plants 12a-12n during a predetermined time period. Comparisons of these plant operational parameters are performed with the process model results from the simulation engine based on the predetermined threshold values.

Also included in the data cleansing system 10 is an interface module 24 for providing an interface between the data cleansing system 10, one or more internal or external databases 26, and the network 16. The interface module 24 receives data from, for example, plant sensors and parameters via the network 16, and other related system devices, services, and applications. The other devices, services, and applications may include, but are not limited to, one or more software or hardware components, etc., related to the respective plants 12a-12n. The interface module 24 also receives the signals and/or parameters, which are communicated to the respective units and modules, such as the data cleansing system 10, and its associated computing modules or units.

A data cleansing unit 28 is provided for performing an enhanced data cleansing process for allowing an early detection and diagnosis of plant operation based on one or more environmental factors. As discussed above, the environmental factors include at least one primary factor, and an optional secondary factor. The primary factor includes, for example, a temperature, a pressure, a feed flow, a product flow, and the like. The secondary factor includes, for example, a density, a specific composition, and the like. An offset amount representing a difference between the feed and product information is calculated and evaluated for detecting an error of specific equipment during plant operation.

In operation, the data cleansing unit 28 receives at least one set of actual measured data from a customer site or plant 12a-12n on a recurring basis at a specified time interval, such as for example, every 100 milliseconds, every second, every ten seconds, every minute, every two minutes, etc. For data cleansing, the received data is analyzed for completeness and corrected for gross errors by the data cleansing unit 28. Then, the data is corrected for measurement issues (e.g., an accuracy problem for establishing a simulation steady state) and overall mass balance closure to generate a duplicate set of reconciled plant data.

By performing data reconciliation over an entire sub-section of the flowsheet, substantially all of the process data relating to particular equipment is used to reconcile the associated operational plant parameters. As described in greater detail below, at least one plant operational parameter, such as a mass flow rate, is utilized in the correction of the mass balance. Offsets calculated for the plant measurements are tracked and stored in the database 26 for subsequent retrieval.

Also included in the present data cleansing system 10 is a diagnosis unit 30 configured for diagnosing an operational status of a measurement based on at least one environmental factor. The diagnosis unit 30 evaluates the calculated offsets between the plant measurements and process simulation based on the at least one environmental factor for detecting a fault or error of specific plant measurement during plant operation. It is advantageous that at least one piece of plant equipment can be evaluated and diagnosed for the fault without distributing measurement errors for the rest of plant equipment.

In a preferred embodiment, the diagnosis unit 30 receives the feed and product information from at least one of the plants 12a-12n to proactively evaluate a specific piece of plant equipment. To evaluate various limits of a particular process and stay within the acceptable range of limits, the diagnosis unit 30 determines target tolerance levels of a final product based on actual current and/or historical operational parameters, e.g., from a flow rate, a heater, a temperature set point, a pressure signal, and the like. When the offsets are different from previously calculated offsets by a predetermined value, the diagnosis unit 30 determines that the specific measurement is faulty or in error. It is contemplated that an additional reliability heuristic analysis may be performed on this diagnosis in certain cases.

In using the kinetic model or other detailed calculations, the diagnosis unit 30 establishes boundaries or thresholds of operating parameters based on existing limits and/or operating conditions. Exemplary existing limits may include mechanical pressures, temperature limits, hydraulic pressure limits, and operating lives of various components. Other suitable limits and conditions are contemplated to suit different applications.

Also included in the present data cleansing system 10 is a prediction unit 32 being configured such that the corrected data is used as an input to a simulation process, in which the process model is tuned to ensure that the simulation process matches the reconciled plant data. The prediction unit 32 performs that an output of the reconciled plant data is inputted into a tuned flowsheet, and then is generated as a predicted data. Each flowsheet may be a collection of virtual process model objects as a unit of process design. A delta value, which is a difference between the reconciled data and the predicted data, is validated to ensure that a viable optimization case is established for a simulation process run.

Also included in the present data cleansing system 10 is an optimization unit 34 being configured such that the tuned simulation engine is used as a basis for the optimization case, which is run with a set of the reconciled data as an input. The output from this step is a new set of data, namely an optimized data. A difference between the reconciled data and the optimized data provides an indication as to how the operations should be changed to reach a greater economic optimum. In this configuration, the data cleansing unit 28 provides a user-configurable method for minimizing objective functions, thereby maximizing production of the plant 12a-12n.

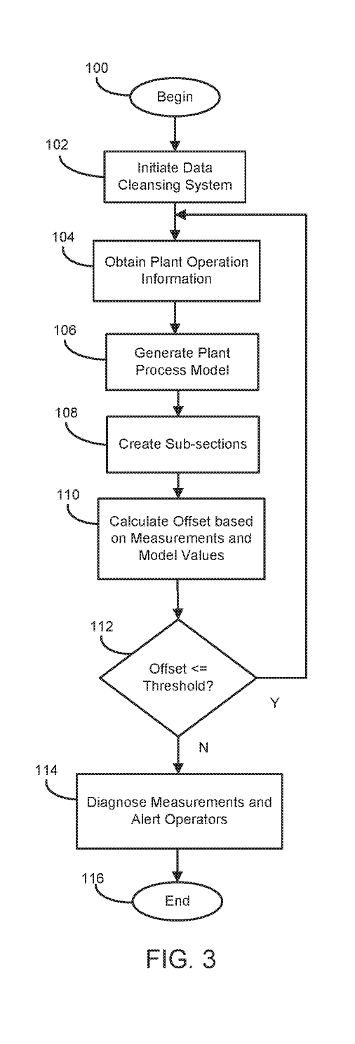

Referring now to FIG. 3, a simplified flow diagram is illustrated for an exemplary method of improving operation of a plant, such as the plant 12a-12n of FIGS. 1 and 2, according to one embodiment of this invention. Although the following steps are primarily described with respect to the embodiments of FIGS. 1 and 2, it should be understood that the steps within the method may be modified and executed in a different order or sequence without altering the principles of the present invention.

The method begins at step 100. In step 102, the data cleansing system 10 is initiated by a computer system that is inside or remote from the plant 12a-12n. The method is desirably automatically performed by the computer system; however, the invention is not intended to be so limited. One or more steps can include manual operations or data inputs from the sensors and other related systems, as desired.

In step 104, the data cleansing system 10 obtains plant operation information or plant data from the plant 12a-12n over the network 16. The desirable plant operation information or plant data includes plant operational parameters, plant process condition data, plant lab data and/or information about plant constraints. As used herein, “plant lab data” refers to the results of periodic laboratory analyses of fluids taken from an operating process plant. As used herein, “plant process condition data” refers to data measured by sensors in the process plant.

In step 106, a plant process model is generated using the plant operation information. The plant process model estimates or predicts plant performance that is expected based upon the plant operation information, i.e., how the plant 12a-12n is operated. The plant process model results can be used to monitor the health of the plant 12a-12n and to determine whether any upset or poor measurement occurred. The plant process model is desirably generated by an iterative process that models at various plant constraints to determine the desired plant process model.

In step 108, a process simulation unit is utilized to model the operation of the plant 12a-12n. Because the simulation for the entire unit would be quite large and complex to solve in a reasonable amount of time, each plant 12a-12n may be divided into smaller virtual sub-sections consisting of related unit operations. An exemplary process simulation unit 10, such as a UniSim® Design Suite, is disclosed in U.S. Patent Publication No. 2010/0262900, now U.S. Pat. No. 9,053,260, which is incorporated by reference in its entirety. Other exemplary related systems are disclosed in commonly assigned U.S. patent application Ser. Nos. ______ and ______ (Attorney Docket Nos. H0049260-01-8500 and H0049324-01-8500 both filed on Mar. 29, 2016), which are incorporated by reference in their entirety.

For example, in one embodiment, a fractionation column and its related equipment such as its condenser, receiver, reboiler, feed exchangers, and pumps would make up a sub-section. All available plant data from the unit, including temperatures, pressures, flows, and laboratory data are included in the simulation as Distributed Control System (DCS) variables. Multiple sets of the plant data are compared against the process model and model fitting parameter and measurement offsets are calculated that generate the smallest errors.

In step 110, fit parameters or offsets that change by more than a predetermined threshold, and measurements that have more than a predetermined range of error may trigger further action. For example, large changes in offsets or fit parameters may indicate the model tuning may be inadequate. Overall data quality for the set of data may then be flagged as questionable.

More specifically, a measured value and corresponding simulated value are evaluated for detecting an error based on a corresponding offset. In a preferred embodiment, an offset is detected when the measured information is not in sync with the simulated information. The system uses evidence from a number of measurements and a process model to determine the simulated information.

As an example only, consider the following measurements: a feed with the composition of 50% component A and 50% component B and a flow of 200 pounds per hour (90.7 kg/hr) and two product streams, the first with a composition 99% component A and a flow of 100 pounds per hour (45.3 kg/hr) and the second with a composition of 99% component B and 95 pounds per hour (43.1 kg/hr). Based on the first-principles model, the total feed must equal the total product and the total amount of A or B in the feed must equal the total amount of A or B in the product. The expected flow of the second product stream would be 100 pounds per hour (45.3 kg/hr) and the operator can therefore assess that the offset between the measurement and simulation is 5 pounds per hour (2.27 kg/hr).

In step 112, when the offset is less than or equal to a predetermined value, control returns to step 104. Otherwise, control proceeds to step 114. Individual measurements with large errors may be eliminated from the fitting algorithm and an alert message or warning signal raised to have the measurement inspected and rectified.

In step 114, the operational status of the measurements is diagnosed based on at least one environmental factor. As discussed above, the calculated offset between the feed and product information is evaluated based on the at least one environmental factor for detecting the fault of a specific measurement. If a measurement is determined to be within a fault status, an alert is sent to the operator. The method ends at step 116.

### Specific Embodiments

While the following is described in conjunction with specific embodiments, it will be understood that this description is intended to illustrate and not limit the scope of the preceding description and the appended claims.

A first embodiment of the invention is a system for improving operation of a plant, the cleansing system comprising a server coupled to the cleansing system for communicating with the plant via a communication network; a computer system having a web-based platform for receiving and sending plant data related to the operation of the plant over the network; a display device for interactively displaying the plant data; and a data cleansing unit configured for performing an enhanced data cleansing process for allowing an early detection and diagnosis of the operation of the plant based on at least one environmental factor, wherein the data cleansing unit calculates and evaluates an offset amount representing a difference between measured and simulated information for detecting an error of measurement during the operation of the plant based on the plant data. An embodiment of the invention is one, any or all of prior embodiments in this paragraph up through the first embodiment in this paragraph, wherein the at least one environmental factor includes at least one primary factor, and an optional secondary factor. An embodiment of the invention is one, any or all of prior embodiments in this paragraph up through the first embodiment in this paragraph, wherein the at least one primary factor includes at least one of a temperature, a pressure, a feed flow, and a product flow. An embodiment of the invention is one, any or all of prior embodiments in this paragraph up through the first embodiment in this paragraph, wherein the optional secondary factor includes at least one of a density value and a specific composition. An embodiment of the invention is one, any or all of prior embodiments in this paragraph up through the first embodiment in this paragraph, wherein the data cleansing unit is configured to receive at least one set of actual measured data from the plant on a recurring basis at a predetermined time interval. An embodiment of the invention is one, any or all of prior embodiments in this paragraph up through the first embodiment in this paragraph, wherein the data cleansing unit is configured to analyze the received data for completeness and correct an error in the received data for a measurement issue and an overall mass balance closure to generate a set of reconciled plant data. An embodiment of the invention is one, any or all of prior embodiments in this paragraph up through the first embodiment in this paragraph, wherein the data cleansing unit is configured such that the corrected data is used as an input to a simulation process, in which the process model is tuned to ensure that the simulation process matches the reconciled plant data. An embodiment of the invention is one, any or all of prior embodiments in this paragraph up through the first embodiment in this paragraph, wherein the data cleansing unit is configured such that an output of the reconciled plant data is inputted into a tuned flowsheet, and is generated as a predicted data. An embodiment of the invention is one, any or all of prior embodiments in this paragraph up through the first embodiment in this paragraph, wherein the data cleansing unit is configured such that a delta value representing a difference between the reconciled plant data and the predicted data is validated to ensure that a viable optimization case is established for a simulation process run. An embodiment of the invention is one, any or all of prior embodiments in this paragraph up through the first embodiment in this paragraph, wherein a tuned simulation engine is used as a basis for the viable optimization case being run with the reconciled plant data as an input, and an output from the turned simulation engine is an optimized data. An embodiment of the invention is one, any or all of prior embodiments in this paragraph up through the first embodiment in this paragraph, wherein a difference between the reconciled data and the optimized data indicates one or more plant variables which are capable of being changed to reach a greater performance for the plant. An embodiment of the invention is one, any or all of prior embodiments in this paragraph up through the first embodiment in this paragraph, further comprising a reconciliation unit configured for reconciling actual measured data from the plant in comparison with a performance process model result from a simulation engine based on a set of predetermined reference or set points. An embodiment of the invention is one, any or all of prior embodiments in this paragraph up through the first embodiment in this paragraph, wherein the reconciliation unit is configured to perform a heuristic analysis against the actual measured data and the performance process model result using a set of predetermined threshold values, and wherein the reconciliation unit is configured to receive the plant data from the plant via the computer system, and the received plant data represents the actual measured data from the equipment in the plant during a predetermined time period. An embodiment of the invention is one, any or all of prior embodiments in this paragraph up through the first embodiment in this paragraph, further comprising a diagnosis unit configured for diagnosing an operational status of the measurement by calculating the offset amount based on the at least one environmental factor. An embodiment of the invention is one, any or all of prior embodiments in this paragraph up through the first embodiment in this paragraph, wherein the diagnosis unit is configured to receive the feed and product information from the plant to evaluate the equipment, and to determine a target tolerance level of a final product based on at least one of an actual current operational parameter and a historical operational parameter for detecting the error of the equipment based on the target tolerance level.

A second embodiment of the invention is a method for improving operation of a plant, the cleansing method comprising providing a server coupled to a cleansing system for communicating with the plant via a communication network; providing a computer system having a web-based platform for receiving and sending plant data related to the operation of the plant over the network; providing a display device for interactively displaying the plant data, the display device being configured for graphically or textually receiving the plant data; obtaining the plant data from the plant over the network; performing an enhanced data cleansing process for allowing an early detection and diagnosis of the operation of the plant based on at least one environmental factor; and calculating and evaluating an offset amount representing a difference between feed and product information for detecting an error of equipment during the operation of the plant based on the plant data. An embodiment of the invention is one, any or all of prior embodiments in this paragraph up through the second embodiment in this paragraph, further comprising generating a plant process model using the plant data, estimating or predicting plant performance expected based on the plant data using the plant process model. An embodiment of the invention is one, any or all of prior embodiments in this paragraph up through the second embodiment in this paragraph, further comprising evaluating the measurement and simulation of the measurement for detecting the error of the measurement. An embodiment of the invention is one, any or all of prior embodiments in this paragraph up through the second embodiment in this paragraph, further comprising detecting the error of the measurement when the corresponding offset is less than or equal to a predetermined value. An embodiment of the invention is one, any or all of prior embodiments in this paragraph up through the second embodiment in this paragraph, further comprising diagnosing an operational status of the measurement by calculating the offset amount based on the at least one environmental factor.

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

What is claimed is:

1. A cleansing system for improving operation of a plant, the cleansing system comprising:
a server coupled to the cleansing system for communicating with the plant via a communication network;
a computer system having a web-based platform for receiving and sending plant data related to the operation of the plant over the network;
a display device for interactively displaying the plant data; and
a data cleansing unit configured for performing an enhanced data cleansing process for allowing an early detection and diagnosis of the operation of the plant based on at least one environmental factor,
wherein the data cleansing unit calculates and evaluates an offset amount representing a difference between measured and simulated information for detecting an error of measurement during the operation of the plant based on the plant data.

2. The cleansing system of claim 1, wherein the at least one environmental factor includes at least one primary factor, and an optional secondary factor.

3. The cleansing system of claim 2, wherein the at least one primary factor includes at least one of: a temperature, a pressure, a feed flow, and a product flow.

4. The cleansing system of claim 2, wherein the optional secondary factor includes at least one of: a density value and a specific composition.

5. The cleansing system of claim 1, wherein the data cleansing unit is configured to receive at least one set of actual measured data from the plant on a recurring basis at a predetermined time interval.

6. The cleansing system of claim 5, wherein the data cleansing unit is configured to analyze the received data for completeness and correct an error in the received data for a measurement issue and an overall mass balance closure to generate a set of reconciled plant data.

7. The cleansing system of claim 6, wherein the data cleansing unit is configured such that the corrected data is used as an input to a simulation process, in which the process model is tuned to ensure that the simulation process matches the reconciled plant data.

8. The cleansing system of claim 6, wherein the data cleansing unit is configured such that an output of the reconciled plant data is inputted into a tuned flowsheet, and is generated as a predicted data.

9. The cleansing system of claim 8, wherein the data cleansing unit is configured such that a delta value representing a difference between the reconciled plant data and the predicted data is validated to ensure that a viable optimization case is established for a simulation process run.

10. The cleansing system of claim 9, wherein a tuned simulation engine is used as a basis for the viable optimization case being run with the reconciled plant data as an input, and an output from the turned simulation engine is an optimized data.

11. The cleansing system of claim 10, wherein a difference between the reconciled data and the optimized data indicates one or more plant variables which are capable of being changed to reach a greater performance for the plant.

12. The cleansing system of claim 1, further comprising a reconciliation unit configured for reconciling actual measured data from the plant in comparison with a performance process model result from a simulation engine based on a set of predetermined reference or set points.

13. The cleansing system of claim 12, wherein the reconciliation unit is configured to perform a heuristic analysis against the actual measured data and the performance process model result using a set of predetermined threshold values, and
wherein the reconciliation unit is configured to receive the plant data from the plant via the computer system, and the received plant data represents the actual measured data from the equipment in the plant during a predetermined time period.

14. The cleansing system of claim 1, further comprising a diagnosis unit configured for diagnosing an operational status of the measurement by calculating the offset amount based on the at least one environmental factor.

15. The cleansing system of claim 14, wherein the diagnosis unit is configured to receive the feed and product information from the plant to evaluate the equipment, and to determine a target tolerance level of a final product based on at least one of: an actual current operational parameter and a historical operational parameter for detecting the error of the equipment based on the target tolerance level.

16. A cleansing method for improving operation of a plant, the cleansing method comprising:
providing a server coupled to a cleansing system for communicating with the plant via a communication network;
providing a computer system having a web-based platform for receiving and sending plant data related to the operation of the plant over the network;
providing a display device for interactively displaying the plant data, the display device being configured for graphically or textually receiving the plant data;
obtaining the plant data from the plant over the network;
performing an enhanced data cleansing process for allowing an early detection and diagnosis of the operation of the plant based on at least one environmental factor; and
calculating and evaluating an offset amount representing a difference between feed and product information for detecting an error of equipment during the operation of the plant based on the plant data.

17. The cleansing method of claim 16, further comprising generating a plant process model using the plant data, estimating or predicting plant performance expected based on the plant data using the plant process model.

18. The cleansing method of claim 16, further comprising evaluating the measurement and simulation of the measurement for detecting the error of the measurement.

19. The cleansing method of claim 18, further comprising detecting the error of the measurement when the corresponding offset is less than or equal to a predetermined value.

20. The cleansing method of claim 16, further comprising diagnosing an operational status of the measurement by calculating the offset amount based on the at least one environmental factor.
